(19) United States
(12) Patent Application Publication
(10) Pub. No.: US 2026/0266910 A1
(43) Pub. Date: Sep. 10, 2026

(54) SECONDARY BATTERY INSPECTION METHOD

(71) Applicant: SAMSUNG SDI CO., LTD., Yongin-si (KR)

(72) Inventors: Taekyu KIM, Yongin-si (KR); Mangi KIM, Yongin-si (KR); Jiseong MOON, Yongin-si (KR)

(21) Appl. No.: 19/322,383

(22) Filed: Sep. 8, 2025

(30) Foreign Application Priority Data
Mar. 7, 2025 (KR) 10-2025-0030158

(51) Int. Cl. G01R 31/367; G01R 31/3835; G01R 31/52

(52) U.S. Cl. CPC G01R 31/367; G01R 31/3835; G01R 31/52

(57) ABSTRACT

A secondary battery inspection method includes: measuring a first voltage value at a first time point of a secondary battery under inspection during a discharge; measuring a second voltage value at a second time point of the secondary battery under inspection; measuring a third voltage value at a third time point of the secondary battery under inspection; and estimating a fourth voltage value at a fourth time point of the secondary battery under inspection based on the first voltage value, the second voltage value, and the third voltage value. The first time point, the second time point, the third time point, and the fourth time point are different from each other.

### CROSS-REFERENCE TO RELATED APPLICATION

The present application claims priority to and the benefit of Korean Patent Application No. 10-2025-0030158, filed on Mar. 7, 2025, in the Korean Intellectual Property Office, the entire disclosure of which is incorporated by reference herein.

### BACKGROUND

### Field

Aspects of embodiments of the present disclosure relate to a secondary battery inspection apparatus and method.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the electrode assembly, and electrode terminals connected to the electrode assembly.

The above information disclosed in this Background section is for enhancement of understanding of the background of the present disclosure, and therefore, it may contain information that does not constitute related (or prior) art.

### SUMMARY

During a manufacturing process of a secondary battery, fine metallic foreign matter may be introduced. Problems may therefore arise in terms of long-term performance of the secondary battery. For example, while charge and discharge cycles are proceeding, an internal short circuit of the secondary battery may be caused by the metallic foreign matter and may ignite the secondary battery, and thus, the lifetime of the secondary battery may be degraded by the metallic foreign matter. In order to prevent or substantially prevent the occurrence of such problems, it may be desirable to preliminarily screen out defective secondary batteries into which metallic foreign matter has been introduced.

Embodiments of the present disclosure may be directed to a secondary battery inspection apparatus and method for identifying detective secondary batteries into which metallic foreign matter has been introduced.

The above and additional aspects and features will be set forth, in part, in the description that follows, and in part, may be apparent from the description, or may be learned by practicing one or more of the presented embodiments of the present disclosure.

According to one or more embodiments of the present disclosure, a secondary battery inspection method includes: measuring a first voltage value at a first time point of a secondary battery under inspection during a discharge; measuring a second voltage value at a second time point of the secondary battery under inspection; measuring a third voltage value at a third time point of the secondary battery under inspection; and estimating a fourth voltage value at a fourth time point of the secondary battery under inspection based on the first voltage value, the second voltage value, and the third voltage value. The first time point, the second time point, the third time point, and the fourth time point are different from each other.

In an embodiment, the first time point, the second time point, the third time point, and the fourth time point may be in chronological order.

In an embodiment, the second time point may be between the first time point and a time point at which 3 days have elapsed from the first time point.

In an embodiment, the third time point may be between a time point at which 5 days have elapsed from the second time point and a time point at which 10 days have elapsed from the second time point.

In an embodiment, the fourth time point may be a time point at which greater than or equal to 30 days have elapsed from the second time point.

In an embodiment, the estimating of the fourth voltage value may include: calculating a first time interval as a difference between the first time point and the second time point; calculating a second time interval as a difference between the first time point and the third time point; and estimating the fourth voltage value based on the first time interval, the second time interval, the first voltage value, the second voltage value, and the third voltage value.

In an embodiment, the estimating of the fourth voltage value may include: calculating a first delta voltage value as a difference between the first voltage value and the second voltage value, based on the first voltage value and the second voltage value; calculating a second delta voltage value as a difference between the first voltage value and the third voltage value, based on the first voltage value and the third voltage value; and estimating the fourth voltage value based on the first delta voltage value and the second delta voltage value.

In an embodiment, the estimating of the fourth voltage value may include: calculating a first time interval as a difference between the first time point and the second time point; calculating a second time interval as a difference between the first time point and the third time point; calculating a first delta voltage value as a difference between the first voltage value and the second voltage value, based on the first voltage value and the second voltage value; calculating a second delta voltage value as a difference between the first voltage value and the third voltage value, based on the first voltage value and the third voltage value; generating a prediction model configured to acquire the fourth voltage value at the fourth time point based on the first time interval, the second time interval, the first delta voltage value, and the second delta voltage value; and acquiring the fourth voltage value using the prediction model.

In an embodiment, the acquiring of the fourth voltage value may include: calculating a third time interval as a difference between the first time point and the fourth time point; and acquiring the fourth voltage value using the prediction model based on the third time interval.

In an embodiment, the secondary battery inspection method may further include: calculating a voltage value change amount associated with a reference time point using the prediction model; and determining whether or not the secondary battery under inspection is defective by comparing the voltage value change amount with a reference value.

In an embodiment, the calculating of the voltage value change amount may include: generating estimated voltage data associated with the reference time point using the prediction model; and calculating the voltage value change amount based on the estimated voltage data.

In an embodiment, the reference value may be calculated based on a differential value of voltage data at the reference time point from voltage data of a plurality of test secondary batteries under a discharge.

In an embodiment, the reference time point may be associated with a time point at which the differential value of the voltage data becomes constant.

In an embodiment, the discharge may correspond to a self-discharge, and the reference time point may be a time point at which greater than or equal to 30 days have elapsed from a day on which the discharge started.

In an embodiment, the reference value may be calculated based on a standard deviation of differential values of voltage data at the reference time point from voltage data of a plurality of test secondary batteries under a discharge.

In an embodiment, the reference value may be within a range of 0.05-0.06205 mV/day.

In an embodiment, the determining of whether or not the secondary battery under inspection is defective may include determining whether or not the secondary battery under inspection is defective after a second inspection when the voltage value change amount is greater than the reference value.

In an embodiment, a determination that the secondary battery under inspection is defective may correspond to a determination that the secondary battery under inspection has an internal short circuit.

In an embodiment, a frozen resistance associated with a defective secondary battery may be less than or equal to a reference resistance.

According to one or more embodiments of the present disclosure, a secondary battery inspection method includes: measuring a first voltage value at a first time point of a secondary battery under inspection during a discharge; measuring a second voltage value at a second time point of the secondary battery under inspection; measuring a third voltage value at a third time point of the secondary battery under inspection; calculating a first time interval as a difference between the first time point and the second time point; calculating a second time interval as a difference between the first time point and the third time point; calculating a first delta voltage value as a difference between the first voltage value and the second voltage value; calculating a second delta voltage value as a difference between the first voltage value and the third voltage value; generating a prediction model configured to acquire a fourth voltage value at a fourth time point based on the first time interval, the second time interval, the first delta voltage value, and the second delta voltage value; and acquiring the fourth voltage value using the prediction model. The first time point, the second time point, the third time point, and the fourth time point are in chronological order.

According to some embodiments of the present disclosure, a secondary battery inspection apparatus may preliminarily screen out defective secondary batteries by using a voltage value variation and a reference value as indicators. In more detail, the secondary battery inspection apparatus may preliminarily screen out defective secondary batteries associated with the introduction of metallic foreign matter into the interior of the secondary battery.

According to some embodiments of the present disclosure, by calculating the reference value in advance and using the calculated reference value, a determination of whether or not the secondary battery under inspection is defective may be performed more rapidly.

According to some embodiments of the present disclosure, a reference time point and the reference value may be calculated as indicators for screening defective products. Through quantified indicators, defective secondary batteries may be screened more simply and clearly.

According to some embodiments of the present disclosure, time and costs used to obtain voltage data of secondary batteries over a long period may be reduced.

According to some embodiments of the present disclosure, a secondary battery inspection method may be non-destructive to the secondary battery, may not use various inspection devices, and may consume relatively smaller time and costs, thereby inspecting secondary batteries more efficiently.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF DRAWINGS

The above and other aspects and features of the present disclosure will be more clearly understood from the following detailed description of the illustrative, non-limiting embodiments with reference to the accompanying drawings.

FIG. 1 is a schematic view illustrating a secondary battery inspection apparatus according to an embodiment of the present disclosure.

FIG. 2 is a schematic view illustrating a secondary battery inspection apparatus according to an embodiment of the present disclosure.

FIG. 3 illustrates a graph of voltage data according to an embodiment of the present disclosure.

FIG. 4 illustrates multiple voltage graphs according to an embodiment of the present disclosure.

FIG. 5 illustrates multiple differential voltage graphs according to an embodiment of the present disclosure.

FIG. 6 illustrates multiple graphs of voltage data according to an embodiment of the present disclosure.

FIG. 7 illustrates multiple graphs of voltage data according to an embodiment of the present disclosure.

FIG. 8 illustrates results of a frozen-resistance experiment according to an embodiment of the present disclosure.

FIG. 9 illustrates measured voltage values and estimated voltage values according to an embodiment of the present disclosure.

FIG. 10 illustrates experimental results of a first prediction model according to an embodiment of the present disclosure.

FIG. 11 illustrates experimental results of a second prediction model according to an embodiment of the present disclosure.

FIG. 12 illustrates experimental results of a third prediction model according to an embodiment of the present disclosure.

FIG. 13 illustrates experimental results of a fourth prediction model according to an embodiment of the present disclosure.

FIG. 14 illustrates experimental results of a fifth prediction model according to an embodiment of the present disclosure.

FIG. 15 illustrates experimental results of a sixth prediction model according to an embodiment of the present disclosure.

FIG. 16 is a flowchart illustrating an example of a secondary battery inspection method according to an embodiment of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, and the like as being “the same” as each other may mean that they are “substantially the same” as each other. Thus, the phrase “substantially the same” may include a case having a deviation or a variation that is considered low in the art, for example, a deviation or variation of 5% or less. In addition, when a certain parameter is referred to as being uniform in a given region, it may mean that it is uniform in terms of an average.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the a plurality forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

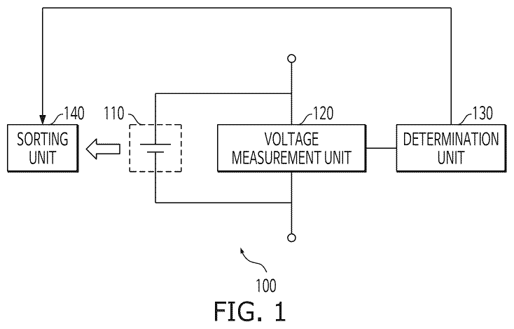

FIG. 1 is a schematic view illustrating a secondary battery inspection apparatus 100 according to an embodiment of the present disclosure.

Referring to FIG. 1, the secondary battery inspection apparatus 100 may include a voltage measurement unit 120, a determination unit 130, and a sorting unit 140. The secondary battery inspection apparatus 100 may determine whether or not a secondary battery under inspection 110 is defective by inspecting the secondary battery under inspection 110.

The secondary battery under inspection 110 may undergo a discharge. For example, the secondary battery under inspection 110 may undergo a self-discharge. For example, the secondary battery under inspection 110 may be a secondary battery in which a formation process is performed after manufacture thereof. In addition, before the discharge, the secondary battery under inspection 110 may be in a fully charged state. For example, the secondary battery under inspection 110 may have a state of charge (SOC) of about one hundred percent. As another example, the secondary battery under inspection 110 may have a state of health (SOH) of about one hundred percent and an SOC of about one hundred percent.

In an embodiment, the discharge may be performed at room temperature. For example, the discharge may be performed at 23° C.-27° C. Because the discharge temperature may affect a discharge rate, the discharge temperature may be maintained to be constant or substantially constant.

The voltage measurement unit 120 may measure the voltage of the secondary battery under inspection 110 during the discharge. In more detail, the voltage measurement unit 120 may measure a first voltage value at a first time point of the secondary battery under inspection 110. The voltage measurement unit 120 may measure a second voltage value at a second time point of the secondary battery under inspection 110. The voltage measurement unit 120 may measure a third voltage value at a third time point of the secondary battery under inspection 110. In this case, the first time point, the second time point, and the third time point may differ from each other. However, the voltage measurement unit 120 is not limited thereto, and may measure the voltage of the secondary battery under inspection 110 at an n-th time point (where n is any natural number of two or more). For example, the n-th time point may be a time point at which about one day has elapsed from the first time point. For example, the n-th time point may be a time point at which about three days have elapsed from the first time point. For example, the n-th time point may be a time point at which ten days have elapsed from the first time point.

In an embodiment, the first time point may be a time (e.g., a start time) at which the discharge of the fully charged secondary battery under inspection 110 is started. In this case, the first voltage value may be associated with a maximum capacity of the secondary battery under inspection 110. At an n-th time point after the first time point, an n-th voltage value of the secondary battery under inspection 110 may be smaller than the first voltage value.

The voltage measurement unit 120 may transmit information on the measured voltage values of the secondary battery under inspection 110 during the discharge to the determination unit 130. The determination unit 130 may record and/or store the transmitted voltage values. In this case, the determination unit 130 may record and/or store the transmitted voltage values in the form of voltage values over time.

For example, the voltage measurement unit 120 may measure a first voltage value at a first time point, a second voltage value at a second time point, and a third voltage value at a third time point of the secondary battery under inspection 110. The first time point, the second time point, and the third time point may be arranged in chronological order. The voltage measurement unit 120 may transmit information relating to the first voltage value, the second voltage value, and the third voltage value to the determination unit 130. The determination unit 130 may record and/or store the first voltage value, the second voltage value, and the third voltage value in the form of voltage values over time.

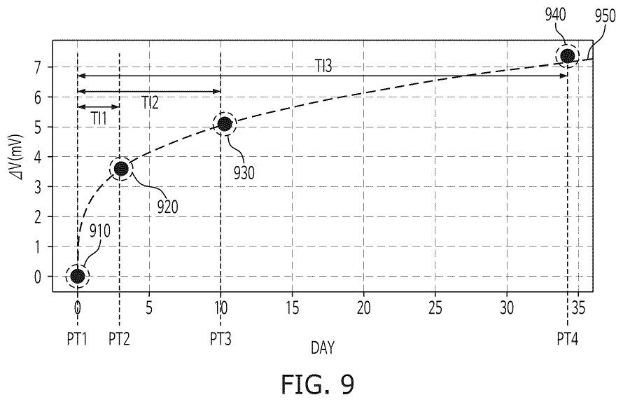

The determination unit 130 may estimate a fourth voltage value at a fourth time point of the secondary battery under inspection 110, based on the first voltage value, the second voltage value, and the third voltage value. For example, the determination unit 130 may generate a prediction model capable of obtaining a fourth voltage value with respect to the secondary battery under inspection 110 at the fourth time point, based on the first voltage value, the second voltage value, and the third voltage value. The fourth time point may be later than the third time point. The determination unit 130 may estimate the fourth voltage value using the prediction model. As such, the determination unit 130 may estimate voltage values for each of a plurality of time points after the third time point. The determination unit 130 may generate estimated voltage data including information on the estimated voltage values. A method of generating the prediction model is described in more detail below with reference to FIGS. 9 to 15.

The determination unit 130 may calculate a voltage value variation over time with respect to the secondary battery under inspection 110. In more detail, the determination unit 130 may calculate a voltage value variation over time between the first time point and the second time point, based on the first voltage value and the second voltage value. Similarly, the determination unit 130 may calculate a voltage value variation over time between an n-th time point and an (n+1)-th time point, based on an n-th voltage value and an (n+1)-th voltage value.

In an embodiment, the voltage value variation over time may be a value obtained by dividing a difference between voltage values by a time interval between the time points. For example, the voltage value variation over time between the first time point and the second time point may be calculated by “(the second voltage value−the first voltage value)/(the second time point−the first time point)”. However, the present disclosure is not limited thereto, and the voltage value variation over time may be calculated in various suitable ways. For example, the voltage value variation over time may be a differential value of voltage values over time.

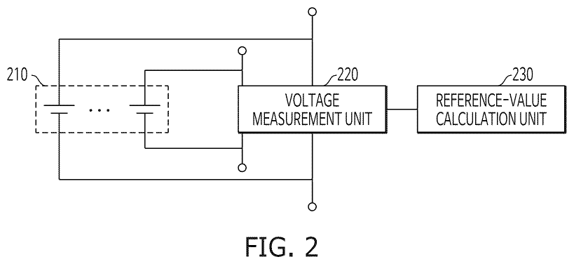

In an embodiment, the determination unit 130 may generate a prediction model for obtaining the fourth voltage value at the fourth time point. For example, the determination unit 130 may calculate a time interval, which is a difference between the first time point and the fourth time point. The determination unit 130 may obtain a voltage value associated with a reference time point (e.g., the reference time point described in more detail below with reference to FIG. 2), based on the prediction model using the time interval. For example, the determination unit 130 may obtain a voltage value for a time point between the third time point and the reference time point, or for a time point after the reference time point, using the prediction model. The determination unit 130 may generate estimated voltage data including information on the obtained voltage value associated with the reference time point. Then, the determination unit 130 may calculate a voltage value variation associated with the reference time point based on the estimated voltage data.

The determination unit 130 may determine whether or not the secondary battery under inspection 110 is defective by comparing the voltage value variation over time with the reference value. In this case, the reference value may be calculated based on voltage data of a plurality of test secondary batteries under discharge. A process of calculating the reference value is described in more detail below with reference to FIGS. 2 to 7.

In an embodiment, the determination unit 130 may generate a determination result indicating that the secondary battery under inspection 110 corresponds to a defective product, or indicating that the secondary battery under inspection 110 does not correspond to a defective product. However, the present disclosure is not limited thereto, and the determination unit 130 may generate various suitable determination results. For example, the determination unit 130 may generate a determination result indicating that the secondary battery under inspection 110 corresponds to a good product. Additionally or as another example, the determination unit 130 may generate a determination result indicating that the secondary battery under inspection 110 corresponds to an intermediate product. The intermediate product may refer to a secondary battery exhibiting a performance between a good product and a defective product. The intermediate product may be a subject of additional inspection. The determination result generated by the determination unit 130 may be transmitted to the sorting unit 140.

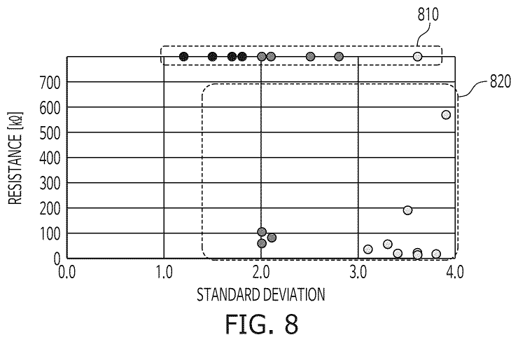

The sorting unit 140 may sort the secondary battery under inspection 110 based on the determination result. For example, the sorting unit 140 may separate the secondary battery under inspection that is determined to be defective from a secondary battery under inspection that is determined not to be defective into separate spaces. In an embodiment, an additional process may be performed on the secondary battery under inspection determined to be defective or to be an intermediate product (e.g., not a fully defective product). For example, as a second inspection, a frozen-resistance test may be performed on the secondary battery under inspection determined to be defective or determined to be an intermediate product. The frozen-resistance test is described in more detail below with reference to FIG. 8.

In an embodiment, when the determination unit 130 determines that the voltage value variation exceeds the reference value, the determination result may be transmitted to the sorting unit 140. The sorting unit 140 may perform a second inspection on the secondary battery under inspection for which the voltage value variation exceeds the reference value. Based on the second inspection result, it may be finally determined whether or not the secondary battery under inspection, for which the voltage value variation exceeds the reference value, is defective.

Referring to FIG. 1, although the secondary battery under inspection 110 is shown as corresponding to one secondary battery or one secondary-battery cell, the present disclosure is not limited thereto. For example, the voltage measurement unit 120 may measure the voltages of a plurality of secondary batteries under inspection 110. Additionally, the determination unit 130 may determine whether or not each of the plurality of secondary batteries under inspection 110 is defective, and the sorting unit 140 may sort secondary batteries that are determined to be defective based on the determination result for each of the plurality of secondary batteries under inspection 110.

Accordingly, the secondary battery inspection apparatus 100 may preliminarily screen out defective secondary batteries by using the voltage value variation and the reference value as indicators. In more detail, the secondary battery inspection apparatus 100 may preliminarily screen out defective secondary batteries associated with the introduction of metallic foreign matter into the interior of the secondary battery.

FIG. 2 is a schematic view illustrating a secondary battery inspection apparatus according to an embodiment of the present disclosure.

Referring to FIG. 2, the secondary battery inspection apparatus may include a configuration (e.g., a device, an integrated circuit, a processor, logic, instructions, or the like) for calculating the reference value. The secondary battery inspection apparatus may include a voltage measurement unit 220 and a reference-value calculation unit 230. The secondary battery inspection apparatus may calculate the reference value using a plurality of test secondary batteries 210.

The test secondary batteries 210 may correspond to secondary batteries separate or different from the secondary battery under inspection 110 of FIG. 1. In other words, the test secondary batteries 210 may not include the secondary battery under inspection 110. In addition, the test secondary batteries 210 may have the same or substantially the same model or the same or substantially the same specifications as those of the secondary battery under inspection 110. Each of the plurality of test secondary batteries 210 may undergo a discharge. For example, each of the plurality of test secondary batteries 210 may undergo a self-discharge. In addition, before the discharge, each of the plurality of test secondary batteries 210 may be in a fully charged state. For example, each test secondary battery 210 may have an SOC of one hundred percent. As another example, each test secondary battery 210 may have an SOH of one hundred percent and an SOC of one hundred percent.

In an embodiment, the number of the plurality of test secondary batteries 210 may be about five thousand or more. However, the number of test secondary batteries may be variously modified as needed or desired, and any amount that is sufficient to secure reliable data may be acceptable.

In an embodiment, discharge conditions of each of the plurality of test secondary batteries 210 may be the same or substantially the same as the discharge conditions of the secondary battery under inspection 110. For example, a discharge temperature of each of the plurality of test secondary batteries 210 may be the same or substantially the same as each other. In addition, the discharge temperature of each of the plurality of test secondary batteries 210 may be the same or substantially the same as the discharge temperature of the secondary battery under inspection 110.

The voltage measurement unit 220 may measure the voltage of each of the plurality of test secondary batteries 210. In more detail, the voltage measurement unit 220 may measure a first voltage value at a first time point for each of the plurality of test secondary batteries 210. The voltage measurement unit 220 may measure a second voltage value at a second time point for each of the plurality of test secondary batteries 210. The voltage measurement unit 220 may measure a third voltage value at a third time point for each of the plurality of test secondary batteries 210. In this case, the first time point, the second time point, and the third time point may be different from each other. However, the voltage measurement unit 220 is not limited thereto, and may measure the voltage of each of the plurality of test secondary batteries 210 at an n-th time point (where n is a natural number of two or more). For example, the n-th time point may be a time point at which one day has elapsed from the first time point. For example, the n-th time point may be a time point at which three days have elapsed from the first time point. For example, the n-th time point may be a time point at which ten days have elapsed from the first time point. For example, the n-th time point may be a time point at which thirty days have elapsed from the first time point.

The voltage measurement unit 220 may transmit the measured voltage values for each of the plurality of test secondary batteries 210 to the reference-value calculation unit 230. The reference-value calculation unit 230 may calculate voltage data of the plurality of test secondary batteries 210 based on the measured voltage values for each of the plurality of test secondary batteries 210. The reference-value calculation unit 230 may calculate the reference value based on the voltage data of the plurality of test secondary batteries 210.

The reference-value calculation unit 230 may calculate the reference value based on differential values of the voltage data of the plurality of test secondary batteries 210. In more detail, the reference-value calculation unit 230 may calculate the reference value based on differential values of the voltage data at the reference time point. The reference time point may be included between a time point (e.g., a start time) at which the voltage measurement for the plurality of test secondary batteries 210 starts and a time point (e.g., an end time) at which the voltage measurement ends. For example, the reference time point may correspond to a time between the first time point and the second time point, a time the same or substantially the same as the first time point, or a time the same or substantially the same as the second time point.

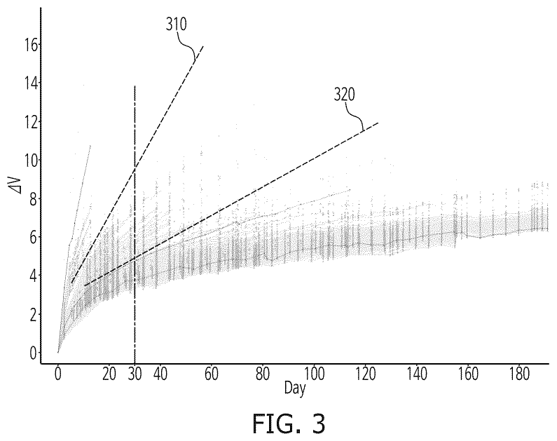

In an embodiment, the reference time point may be calculated based on the voltage data. In other embodiment, the reference time point may be calculated based on the voltage values of the plurality of secondary batteries under inspection 110. A process of calculating the reference time point is described in more detail below with reference to FIGS. 3 to 8.

The reference-value calculation unit 230 may transmit the calculated reference value to the determination unit 130 of FIG. 1. The calculated reference value may be used by the determination unit 130 to determine whether or not the secondary battery under inspection 110 is defective. As such, by calculating the reference value in advance and using the calculated reference value, a determination as to whether or not the secondary battery under inspection 110 is defective may be performed more rapidly.

In an embodiment, the secondary battery inspection apparatus may include a memory and a processor. Referring to FIGS. 1 and 2, the secondary battery inspection apparatus may include at least one of the voltage measurement unit 120, the determination unit 130, the sorting unit 140, the voltage measurement unit 220, or the reference-value calculation unit 230. In this case, at least some of a plurality of configurations (e.g., the voltage measurement unit 120, the determination unit 130, the sorting unit 140, the voltage measurement unit 220, and/or the reference-value calculation unit 230) included in the secondary battery inspection apparatus may include the memory and the processor.

The memory may include any suitable non-transitory computer-readable recording medium. According to an embodiment, the memory may include a permanent mass storage device, such as RAM, ROM, a disk drive, an SSD, or flash memory. As another example, non-volatile mass storage devices, such as ROM, SSD, flash memory, or a disk drive, may be included in a battery-module design system as a separate permanent storage device distinct from the memory. In addition, the memory may store an operating system and at least one program code (e.g., code for performing a secondary-battery inspection executed by the secondary battery inspection apparatus).

The processor may process instructions of a computer program by performing basic arithmetic, logic, and input/output operations. The instructions may be provided to experimental devices, external devices, or other external systems by the memory or a communication module. For example, the processor may estimate a fourth voltage value for the secondary battery under inspection based on the first voltage value, the second voltage value, and the third voltage value.

Additionally, the secondary battery inspection apparatus may further include a communication module. The communication module may provide a configuration or a function for the secondary battery inspection apparatus to communicate with external devices or external systems. For example, control signals, commands, and data provided under the control of the processor of the secondary battery inspection apparatus may be transmitted to a charging device, an external device, and/or an external system through the communication module of the external device and/or the external system.

FIG. 3 illustrates a graph of voltage data according to an embodiment of the present disclosure.

The voltage data may be data obtained by measuring voltages of the plurality of test secondary batteries 210 under discharge as described above with reference to FIG. 2 at a plurality of time points. In addition, the voltage data may be data obtained by measuring voltages of the plurality of secondary batteries under inspection (e.g., the secondary battery under inspection 110 of FIG. 1) at the plurality of time points. For convenience of illustration, the secondary batteries used for generating the voltage data are referred to as the test secondary batteries, but the same applies to the secondary batteries under inspection.

In FIG. 3, the X-axis represents time, and the unit thereof may be in days. The X-axis may represent the elapsed time from a first day in which voltage measurement is started (e.g., from the first day of voltage measurement). In this case, the first measurement may be performed immediately after the test secondary batteries are discharged.

In FIG. 3, the Y-axis represents voltage values, and the unit thereof may be in mV. The voltage values shown on the Y-axis may be differences of voltage values. For example, with reference to a voltage value measured at the first measurement, differences of voltage values measured at respective time points may be represented. In this case, the difference values may be represented as absolute values.

Referring to FIG. 3, a plurality of voltage graphs connecting a plurality of points may be displayed. One voltage graph connecting a plurality of points may be a graph in which measured values for one test secondary battery are sequentially connected linearly. One point may be a measured value for one test secondary battery at one time point.

The voltage data may be data in which voltages are measured at a plurality of time points between a time point immediately after discharge starts and a time point at which two hundred days or more have elapsed from the day on which discharge starts. At each of the plurality of time points, voltage measurement for each of the plurality of test secondary batteries may be performed concurrently (e.g., simultaneously or substantially simultaneously) with each other. For example, at a time point at which thirty days have elapsed from the day on which discharge starts, a voltage measurement for each of the plurality of test secondary batteries may be performed concurrently (e.g., simultaneously or substantially simultaneously) with each other.

Each of the plurality of voltage graphs may exhibit a logarithmic-function or a polynomial-function shape at an initial discharge stage. For example, before thirty days have elapsed from the day on which discharge starts, each of the plurality of voltage graphs may exhibit a logarithmic-function or a polynomial-function shape having a slope that becomes gentle. After a period (e.g., a predetermined period) has elapsed from the day on which discharge starts, each of the plurality of voltage graphs may exhibit a linear-function shape. For example, at a time point at which about thirty days have elapsed from the day on which discharge starts (e.g., the chain line shown in FIG. 3), each of the plurality of voltage graphs may exhibit a linear-function shape. The time point at which each of the plurality of voltage graphs exhibits the linear-function shape may be the reference time point.

Depending on the degree of an internal short circuit of the cell, the slope of a voltage graph of a test secondary battery may differ. In more detail, as the degree of the internal short circuit of the cell increases, the discharge rate of the test secondary battery may increase as discharge continues. Referring to FIG. 3, a test secondary battery corresponding to a voltage graph located above a first linear graph 310 may have a high degree of an internal short circuit of the cell. A test secondary battery corresponding to a voltage graph located below a second linear graph 320 may have a low degree of an internal short circuit of the cell. Through such comparison, test secondary batteries corresponding to voltage graphs located above the first linear graph 310 may be classified as defective products, test secondary batteries corresponding to voltage graphs located below the first linear graph 310 and above the second linear graph 320 may be classified as intermediate products, and test secondary batteries corresponding to voltage graphs located below the second linear graph 320 may be classified as good products. By using such tendencies of secondary batteries, the reference value for the reference time point may be calculated, and whether or not a secondary battery is defective may be determined by comparing the reference value with the voltage value variation over time.

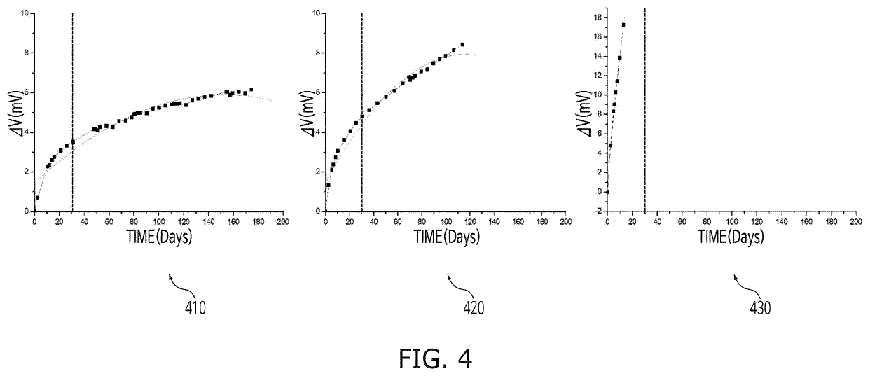

FIG. 4 illustrates multiple voltage graphs 410, 420, and 430 according to an embodiment of the present disclosure.

Referring to FIG. 4, the multiple voltage graphs may be part of the voltage graphs described above with reference to FIG. 3. A first voltage graph 410 may correspond to a good product. A second voltage graph 420 may correspond to an intermediate product. A third voltage graph 430 may correspond to a defective product. Each voltage graph may be displayed together with a polynomial function calculated by performing a polynomial regression on the plurality of points connected by the voltage graph.

Overall, the first voltage graph 410 may be gentler than the second voltage graph 420, and the second voltage graph 420 may be gentler than the third voltage graph 430. In more detail, at a time point at which thirty days have elapsed from the discharge, a differential value of the first voltage graph 410 may be smaller than a differential value of the second voltage graph 420, and a differential value of the second voltage graph 420 may be smaller than a differential value of the third voltage graph 430. Referring to FIG. 4, because the third voltage graph 430 has a large variation in Y-values, data associated with a time point at which thirty days have elapsed from the discharge may not be obtained.

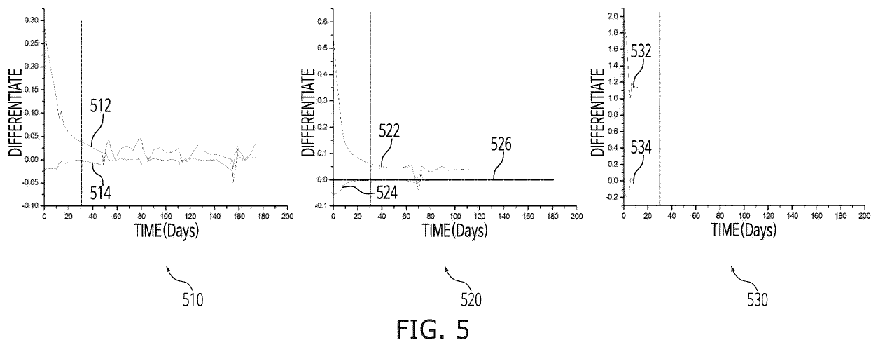

FIG. 5 illustrates multiple differential voltage graphs 510, 520, and 530 according to an embodiment of the present disclosure.

Referring to FIG. 5. a first differential voltage graph 510 may be a graph obtained by differentiating the first voltage graph 410 of FIG. 4. Similarly, a second differential voltage graph 520 may be a graph obtained by differentiating the second voltage graph 420 of FIG. 4. A third differential voltage graph 530 may be a graph obtained by differentiating the third voltage graph 430 of FIG. 4.

Referring to FIG. 5, in the first differential voltage graph 510, a first-order differential graph 512 of the first voltage graph and a second-order differential graph 514 of the first voltage graph may be displayed. Similarly, in the second differential voltage graph 520, a first-order differential graph 522 of the second voltage graph and a second-order differential graph 524 of the second voltage graph may be displayed. In the third differential voltage graph 530, a first-order differential graph 532 of the third voltage graph and a second-order differential graph 534 of the third voltage graph may be displayed. The third differential voltage graph 530 corresponds to a defective product, and may not correspond to a meaningful graph.

In each of the first-order differential graphs 512, 522, and 532, when a suitable time (e.g., a predetermined time) has elapsed from the day on which the discharge starts, a time point at which the first-order differential value becomes constant or substantially constant may appear. The time point at which the first-order differential value becomes constant or substantially constant may correspond to a time point at which the second-order differential value converges to zero. Referring to FIG. 5, in the first differential voltage graph 510, at a time point at which thirty days have elapsed from the day on which the discharge starts (e.g., the dotted line in the first differential voltage graph 510), the first-order differential value becomes constant or substantially constant, and the second-order differential value converges to zero. Similarly, in the second differential voltage graph 520, at a time point at which thirty days have elapsed from the day on which the discharge starts (e.g., the dotted line in the second differential voltage graph 520), the first-order differential value becomes constant or substantially constant, and the second-order differential value converges to zero. In more detail, in the second-order differential graph 524 of the second voltage graph, it may be confirmed that the second-order differential value converges to a line (e.g., the chain double-dash line 526 in the second graph 520) where the second-order differential value is zero. Considering that the voltage graph exhibits a linear-function shape at a time point at which about thirty days have elapsed from the day on which the discharge starts, the reference time point may be determined to be the time point at which thirty days have elapsed from the day on which the discharge starts.

In an embodiment, a secondary battery corresponding to the second differential voltage graph 520 may be a sampled secondary battery. For example, when the voltage data are for the plurality of test secondary batteries, a sampled secondary battery may be sampled from the plurality of test secondary batteries. As another example, when the voltage data are for the plurality of test secondary batteries, the sampled secondary battery may be sampled from the plurality of secondary batteries under inspection (e.g., the secondary battery under inspection 110 of FIG. 1). For convenience of illustration, the plurality of test secondary batteries are used as a reference, but the same applies to the plurality of secondary batteries under inspection.

In an embodiment, the sampled secondary battery may be a secondary battery sampled from the plurality of test secondary batteries based on the voltage differential values at the reference time point of the plurality of test secondary batteries. For example, a secondary battery corresponding to an average of the voltage differential values at the reference time point of the plurality of test secondary batteries may be selected as the sampled secondary battery. As another example, a secondary battery corresponding to a median of the voltage differential values at the reference time point of the plurality of test secondary batteries may be selected as the sampled secondary battery. As another example, a secondary battery corresponding to the upper seventy percent of the voltage differential values at the reference time point of the plurality of test secondary batteries may be selected as the sampled secondary battery.

The voltage differential value at the reference time point of the sampled secondary battery may be used as the reference value. For example, the voltage differential value at the reference time point of the sampled secondary battery corresponding to the second differential voltage graph 520 may fall within a range of about 0.05-0.06205 mV/day. For example, when the voltage differential value at the reference time point of the sampled secondary battery corresponding to the second differential voltage graph 520 is 0.05 mV/day, the reference value may be determined to be 0.05 mV/day. In this case, the reference value may be compared with the voltage value variation over time for the secondary battery under inspection, so that whether or not the secondary battery under inspection is defective may be determined.

In an embodiment, instead of the plurality of test secondary batteries described above with reference to FIG. 3, a voltage value measurement may be performed for the secondary battery under inspection. For example, a first voltage value at a first time point may be measured for the secondary battery under inspection, and a second voltage value at a second time point, which differs from the first time point, may be measured. In this case, the first time point may precede or be the same or substantially the same as the reference time point. The second time point may follow or be the same or substantially the same as the reference time point.

The determination unit (e.g., the determination unit 130 of FIG. 1) may calculate a voltage value variation over time between the first time point and the second time point, based on the first voltage value and the second voltage value. For example, the voltage value variation over time may be an average change rate over time of the first voltage value and the second voltage value. As another example, the voltage value variation over time may be a differential value at the reference time point in a function (e.g., a polynomial function obtained via a polynomial regression, a graph connecting the first voltage value and the second voltage value with a linear function, or the like) calculated based on the first voltage value and the second voltage value.

Thereafter, the determination unit may determine whether or not the secondary battery under inspection is defective by comparing the voltage value variation over time with the reference value. For example, when the voltage value variation exceeds the reference value, the slope of the voltage graph may be steep, indicating that the degree of an internal short circuit of the cell may be high. In this case, the determination unit may determine the corresponding secondary battery under inspection to be defective.

As described above, the reference time point and the reference value may be calculated as indicators for screening defective products. Through quantified indicators, secondary-battery defect screening may be performed more simply and clearly.

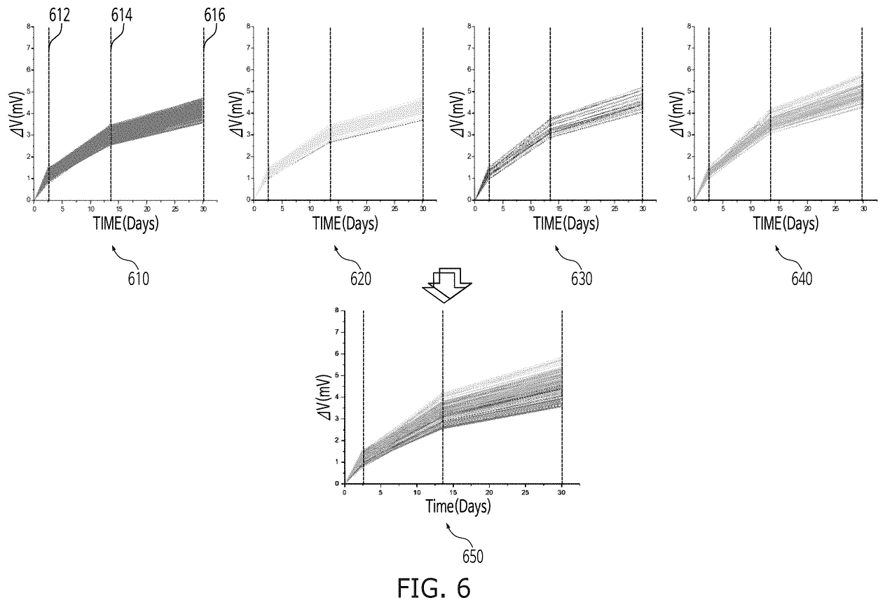

FIG. 6 illustrates multiple graphs 610, 620, 630, 640, and 650 of voltage data according to an embodiment of the present disclosure.

Referring to FIG. 6, the voltage data may be data obtained by measuring voltages of the plurality of test secondary batteries 210 under discharge as described above with reference to FIG. 2 at a plurality of time points. In addition, the voltage data may be data obtained by measuring voltages of the plurality of secondary batteries under inspection (e.g., the secondary battery under inspection 110 of FIG. 1) at the plurality of time points. For convenience of illustration, the secondary batteries used for generating the voltage data are referred to as the test secondary batteries, but the same applies to the secondary batteries under inspection.

In the graphs of FIG. 6, the X-axis represents time, and the unit thereof may be in days. The X-axis may represent the elapsed time from a first day on which a voltage measurement starts. In this case, the first measurement may be performed immediately after the test secondary batteries are discharged.

In the graphs of FIG. 6, the Y-axis represents voltage values, and the unit thereof may be in mV. The voltage values shown on the Y-axis may be differences of voltage values. For example, differences of voltage values measured at respective time points may be represented with reference to a voltage value measured at the first measurement. In this case, the difference values may be represented as absolute values.

In an embodiment, the voltage data may be data obtained by measuring voltages of the plurality of test secondary batteries at a first time point 612, a second time point 614, and a third time point 616. Referring to FIG. 6, the first time point 612 is a time point at which about three days have elapsed from the day on which the discharge starts, the second time point 614 is a time point at which about twelve days have elapsed from the day on which the discharge starts, and the third time point 616 is a time point at which about thirty days have elapsed from the day on which the discharge starts. The time points shown in FIG. 6 are illustrated as examples, and may be variously modified as needed or desired. Each time point may be applied the same or substantially the same to the multiple graphs 610, 620, 630, 640, and 650.

Based on the voltage data, voltage differential values at the reference time point for each of the plurality of test secondary batteries may be calculated. In more detail, a voltage differential value of one test secondary battery at the reference time point may be calculated based on voltage values measured at each of the first time point 612, the second time point 614, and the third time point 616. For example, the voltage differential value of the test secondary battery at the reference time point may be a differential value at the reference time point of a polynomial function calculated by performing a polynomial regression based on voltages measured at the first time point 612, the second time point 614, and the third time point 616. As another example, when the reference time point is between the first time point 612 and the second time point 614, is the same or substantially the same as the first time point 612, or is the same or substantially the same as the second time point 614, the voltage differential value of the test secondary battery at the reference time point may be a voltage value variation over time between the first time point 612 and the second time point 614. Similarly, when the reference time point is between the second time point 614 and the third time point 616, is the same or substantially the same as the second time point 614, or is the same or substantially the same as the third time point 616, the voltage differential value of the test secondary battery at the reference time point may be a voltage value variation over time between the second time point 614 and the third time point 616.

When the number of test secondary batteries is a plurality, the voltage differential values at the reference time point for each of the plurality of test secondary batteries may be classified according to a statistical distribution. In more detail, the statistical distribution may be represented by a standard deviation. The standard deviation may be a numeral indicating the degree of dispersion of a statistical population, and may be represented by σ. For example, when the range of a statistical value in a statistical population is within 2σ, the probability that the statistical value falls within the statistical value range may be 95.4 percent.

For example, a first graph 610 may represent voltage graphs of test secondary batteries having voltage differential values that fall within a 1σ range among the plurality of test secondary batteries. For example, a second graph 620 may represent voltage graphs of test secondary batteries having voltage differential values that fall within a range between 1σ and 2σ among the plurality of test secondary batteries. For example, a third graph 630 may represent voltage graphs of test secondary batteries having voltage differential values that fall within a range between 2σ and 3σ among the plurality of test secondary batteries. For example, a fourth graph 640 may represent voltage graphs of test secondary batteries having voltage differential values that fall within a range exceeding 3σ among the plurality of test secondary batteries. A composite graph 650 may represent a combination of the first graph 610, the second graph 620, the third graph 630, and the fourth graph 640.

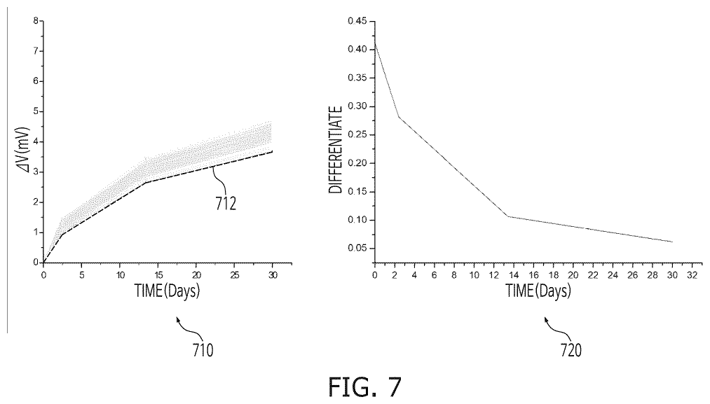

FIG. 7 illustrates multiple graphs of voltage data according to an embodiment of the present disclosure.

Referring to FIG. 7, a first graph 710 may be the same or substantially the same as the second graph 620 of FIG. 6. The first graph 710 may include a voltage graph 712 of a sampled secondary battery.

The sampled secondary battery may be selected using the standard deviation associated with the voltage differential values at the reference time point for the voltage data of the plurality of test secondary batteries. For example, the voltage differential values at the reference time point for each of the plurality of test secondary batteries may be classified according to a statistical distribution. Among them, a secondary battery having a voltage differential value at the reference time point that corresponds to 1σ may be sampled. For example, a secondary battery having a voltage differential value at the reference time point that corresponds to xσ (where x is a real number greater than zero) may be sampled.

Referring to FIG. 7, a secondary battery having a voltage differential value at the reference time point that corresponds to 2σ may be sampled. The voltage graph 712 of the sampled secondary battery may be shown. A second graph 720 may be a graph obtained by differentiating the voltage graph 712 of the sampled secondary battery.

In an embodiment, the reference time point may be a time point at which thirty days have elapsed from the day on which the discharge starts. For example, the voltage differential value of the sampled secondary battery at the reference time point may fall within a range of about 0.05-0.06205 mV/day. Referring to FIG. 7, the voltage differential value of the sampled secondary battery at the reference time point may be 0.06205 mV/day. In this case, the reference value may be about 0.06205 mV/day. In other words, the reference value may be calculated from the voltage data of the plurality of test secondary batteries under discharge, based on a standard deviation of the differential values of the voltage data at the reference time point. The reference value may be compared with the voltage value variation over time for the secondary battery under inspection, so that whether or not the secondary battery under inspection is defective may be determined.

FIG. 8 illustrates results of a frozen-resistance experiment according to an embodiment of the present disclosure. For example, FIG. 8 illustrates results of measuring the frozen resistance according to an embodiment of the present disclosure.

Referring to FIG. 8, the frozen resistance may be measured for the plurality of test secondary batteries used to generate the voltage data of FIGS. 6 and 7. For example, resistances of the plurality of test secondary batteries corresponding to −190° C. to −180° C. may be measured.

Referring to FIG. 8, the X-axis represents the standard deviation corresponding to the voltage differential value at the reference time point for each of the plurality of test secondary batteries. The Y-axis represents the magnitude of resistance, and the unit thereof may be in kΩ. In other words, in FIG. 8, the magnitude of the frozen resistance may be verified according to the magnitude of the standard deviation corresponding to the voltage differential value at the reference time point for each of the plurality of test secondary batteries. A tendency in which the magnitude of the frozen resistance decreases as the magnitude of the standard deviation corresponding to the voltage differential value at the reference time point increases may be confirmed. A secondary battery having an internal short circuit due to metallic foreign matter present inside the secondary battery may have a smaller frozen resistance. In other words, it may be confirmed that the greater the magnitude of the standard deviation corresponding to the voltage differential value at the reference time point, the greater the degree of the internal short circuit of the secondary battery.

In more detail, a non-short secondary battery 810 may have a frozen resistance magnitude exceeding about 700 kΩ. A short secondary battery 820 may have a frozen resistance magnitude of about 700 kΩ or less. The non-short secondary battery 810 may not be associated with a defective product. The short secondary battery 820 may be associated with a defective product.

The standard deviation corresponding to the voltage differential value at the reference time point for the short-circuited secondary battery 820 may have a tendency to be relatively greater than that for the non-short-circuited secondary battery 810. In other words, by using a reference value associated with the standard deviation corresponding to the voltage differential value at the reference time point as a boundary, the non-short-circuited secondary battery 810 and the short-circuited secondary battery 820 may be distinguished from each other. Referring to FIG. 8, the voltage differential value at the reference time point corresponding to 2σ, where both the non-short-circuited secondary battery 810 and the short-circuited secondary battery 820 coexist, may be determined as the reference value.

Because metallic foreign matter may be introduced into a secondary battery, an insulating function between a positive electrode and a negative electrode may be weakened and destroyed. As a result, an internal short circuit of the secondary battery may occur, and a voltage drop of the secondary battery over time may increase. By using the voltage differential value, which reflects such characteristics, secondary batteries into which metallic foreign matter has been introduced may be screened in advance.

FIG. 9 illustrates a graph showing measured voltage values and estimated voltage values according to an embodiment of the present disclosure.

The voltage measurement unit (e.g., the voltage measurement unit 120 of FIG. 1) may measure voltage values of the secondary battery under inspection that undergoes a discharge (e.g., a self-discharge) at a plurality of time points. For example, in measuring the voltage values of the secondary battery under inspection, the voltage measurement unit may measure voltage values corresponding to a first time point PT1, a second time point PT2, and a third time point PT3.

In the graph of FIG. 9, the X-axis represents time, and the unit thereof may be in days. The X-axis may represent the elapsed time from a day in which the voltage of the secondary battery is measured. In this case, the first measurement may be performed immediately after the fully charged secondary battery under inspection is discharged. The Y-axis represents voltage values, and the unit thereof may be in mV. The voltage values shown on the Y-axis may be differences of voltage values. For example, the differences of voltage values measured at respective time points may be represented with reference to a voltage value obtained through the first measurement. In this case, the difference values may be represented as absolute values.

In the graph of FIG. 9, a first point 910 may represent the first voltage value at the first time point PT1. A second point 920 may represent the second voltage value at the second time point PT2. A third point 930 may represent the third voltage value at the third time point PT3. A fourth point 940 may represent the fourth voltage value at a fourth time point PT4. The first point 910 through the third point 930 may represent measured voltage values, and the fourth point 940 may represent an estimated voltage value. A trend line 950 may be calculated by performing a polynomial regression or the like on the first point 910 through the third point 930.

In an embodiment, the first time point PT1, the second time point PT2, the third time point PT3, and the fourth time point PT4 may differ from each other. In more detail, the first time point PT1, the second time point PT2, the third time point PT3, and the fourth time point PT4 may be arranged in chronological order. For example, the first time point PT1 may correspond to a time immediately after the discharge of the secondary battery under inspection. The second time point PT2 may correspond to a time between the first time point PT1 and a time at which about three days have elapsed from the first time point PT1. The third time point PT3 may correspond to a time between a time at which about five days have elapsed from the second time point PT2 and a time at which about ten days have elapsed from the second time point PT2. The fourth time point PT4 may correspond to a time at which a period (e.g., a predetermined period) TI3 has elapsed from the first time point PT1. For example, the period TI3 may be about thirty days or more. As another example, the fourth time point PT4 may correspond to a time before, the same or substantially the same as, or after the reference time point described above with reference to FIGS. 3 to 8.

In an embodiment, the determination unit (e.g., the determination unit 130 of FIG. 1) may estimate the fourth voltage value at the fourth time point PT4 of the secondary battery under inspection based on the first voltage value, the second voltage value, and the third voltage value. In more detail, the determination unit may generate a prediction model for obtaining the fourth voltage value at the fourth time point PT4. For example, the determination unit may calculate a first time interval TI1, which is a difference between the first time point PT1 and the second time point PT2. The determination unit may calculate a second time interval TI2, which is a difference between the first time point PT1 and the third time point PT3. In addition, the determination unit may calculate a first delta voltage value, which is the difference between the first voltage value and the second voltage value, based on the first voltage value and the second voltage value. The determination unit may calculate a second delta voltage value, which is the difference between the first voltage value and the third voltage value, based on the first voltage value and the third voltage value. For example, the first delta voltage value may satisfy “|first voltage value−second voltage value|”, and the second delta voltage value may satisfy “|first voltage value−third voltage value|”. The determination unit may generate the prediction model based on the first time interval TI1, the second time interval TI2, the first delta voltage value, and the second delta voltage value. Then, the determination unit may obtain the fourth voltage value at the fourth time point PT4 using the prediction model.

Hereinafter, the first delta voltage value is referred to as ΔV1, and the second delta voltage value is referred to as ΔV2. The prediction model may be generated using the mathematical expression “fourth voltage value=Intercept+slope·ln(TI3)−ΔV1”. In the mathematical expression, “Intercept” may be a y-intercept value generated by performing a linear-regression analysis with ΔV1 and ΔV2 as an X-axis and ln(TI1) and ln(TI2) as a Y-axis. In the mathematical expression, “slope” may be a slope value generated by performing a linear-regression analysis with ΔV1 and ΔV2 as an X-axis and ln(TI1) and ln(TI2) as a Y-axis. In the mathematical expression, “TI3” may represent a third time interval, which is the difference between the first time point PT1 and the fourth time point PT4.

The prediction model may be generated based on the first voltage value at the first time point PT1, the second voltage value at the second time point PT2, and the third voltage value at the third time point PT3. The prediction model may receive information (e.g., the third time interval TI3) relating to the fourth time point PT4, and may output the fourth voltage value at the fourth time point PT4. In other words, the prediction model may be a model that may be used for the secondary battery under inspection having first through third voltage values that are measured, and may receive information relating to a time point to be predicted to output the voltage value at the predicted time point. As such, the prediction model may output voltage values for time points after the third time point PT3, and may generate estimated voltage data based on the output voltage values. The estimated voltage data may include information on the voltage values obtained by the prediction model.

As described above, instead of measuring all voltage values (e.g., open-circuit-voltage values) of a secondary battery over a longer period (e.g., thirty days or more), voltage values at a suitable number (e.g., a predetermined number) of times (e.g., three times) within an initial period (e.g., a period between immediately after the discharge and ten days after the discharge) may be measured, and the voltage values over the longer period may be estimated. Thus, time and costs used to obtain the voltage data of the secondary battery may be reduced.

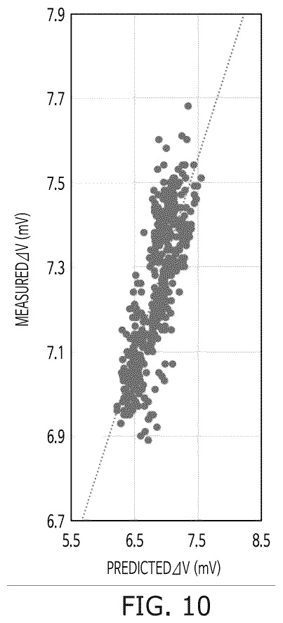

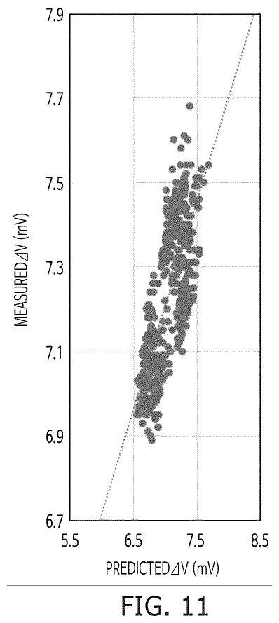

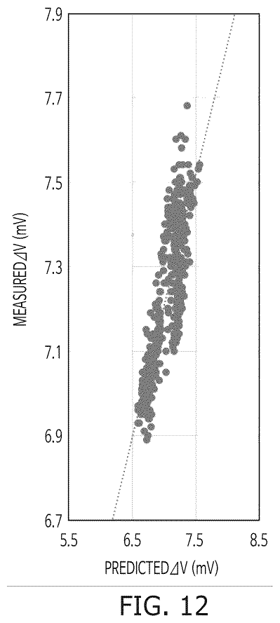

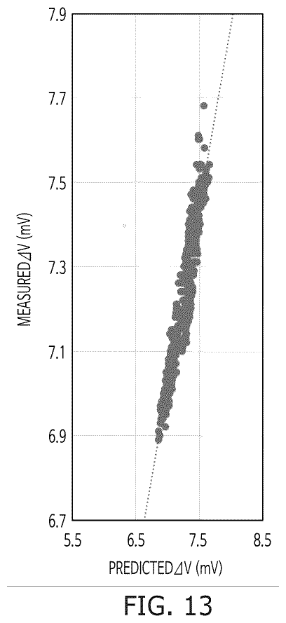

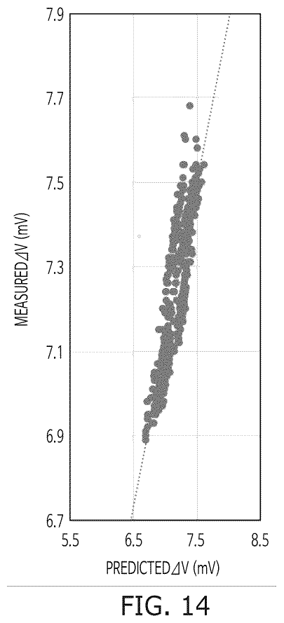

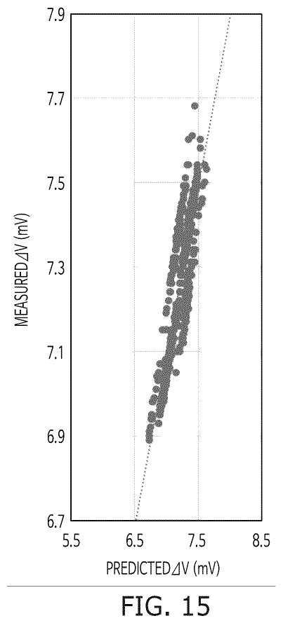

FIG. 10 illustrates experimental results of a first prediction model according to an embodiment of the present disclosure. FIG. 11 illustrates experimental results of a second prediction model according to an embodiment of the present disclosure. FIG. 12 illustrates experimental results of a third prediction model according to an embodiment of the present disclosure. FIG. 13 illustrates experimental results of a fourth prediction model according to an embodiment of the present disclosure. FIG. 14 illustrates experimental results of a fifth prediction model according to an embodiment of the present disclosure. FIG. 15 illustrates experimental results of a sixth prediction model according to an embodiment of the present disclosure. The first through sixth prediction models may be generated using the prediction-model generation method described above with reference to FIG. 9.

In FIGS. 10 to 15, the X-axis of each graph represents a predicted ΔV, which is the difference between the first voltage value at the first time point (e.g., the first time point PT1 of FIG. 9) and the estimated fourth voltage value at the fourth time point (e.g., the fourth time point PT4 of FIG. 9). The estimated fourth voltage value is a voltage value estimated by each prediction model (e.g., the first prediction model, second prediction model, third prediction model, and the like) for the secondary battery under inspection at the fourth time point. In this case, the difference value is positive as an absolute value.

In FIGS. 10 to 15, the Y-axis of each graph represents a measured ΔV, which is the difference between the first voltage value at the first time point and the measured fourth voltage value at the fourth time point. The measured fourth voltage value is a voltage value measured for the secondary battery under inspection at the fourth time point. In this case, the difference value is positive as an absolute value.

In FIGS. 10 to 15, the fourth time point is a time point at which about thirty days have elapsed from the first time point. In the graphs of FIGS. 10-15, each point represents an experimental result for one secondary battery under inspection. In other words, one experiment includes estimating the voltage value at the fourth time point using the prediction model for one secondary battery under inspection and measuring the voltage value at the fourth time point, and one experiment is represented by one point. For example, in the graph of FIG. 10, one point represents information on the measured voltage value and the voltage value predicted by the first prediction model for one secondary battery under inspection. In other words, each point among the plurality of points shown in each graph represents a corresponding one of the plurality of secondary batteries under inspection. In the experiments of FIGS. 10 to 15, the secondary batteries under inspection used are PHEV2 models installed in a BMW vehicle kind.

In the first through sixth prediction models, the second time point PT2 is the same or substantially the same as a time point at which about three days have elapsed from the first time point PT1, and the third time point (e.g., the third time point PT3 of FIG. 9) is varied. For example, in the first prediction model, the third time point is a time point at which about two days have elapsed from the first time point. For example, in the second prediction model, the third time point is a time point at which about five days have elapsed from the first time point. For example, in the third prediction model, the third time point is a time point at which about seven days have elapsed from the first time point. For example, in the fourth prediction model, the third time point is a time point at which about ten days have elapsed from the first time point. For example, in the fifth prediction model, the third time point is a time point at which about thirteen days have elapsed from the first time point. For example, in the sixth prediction model, the third time point is a time point at which about sixteen days have elapsed from the first time point.

The dotted line shown in FIGS. 10 to 15 is a trend line of the plurality of points. The trend line represents a first-order function calculated through a linear-regression analysis of the plurality of points.

The accuracy of the experimental results for each point may be calculated. The accuracy may be calculated by “1−|predicted ΔV−measured ΔV|/(measured ΔV)”. For a plurality of experiments using one prediction model, a plurality of accuracies may be calculated, and the accuracy for one prediction model may be calculated by averaging the plurality of accuracies.

The accuracy of the first prediction model corresponding to the graph of FIG. 10 is about 94.1 percent. The accuracy of the second prediction model corresponding to the graph of FIG. 11 is about 97.0 percent. The accuracy of the third prediction model corresponding to the graph of FIG. 12 is about 97.3 percent. The accuracy of the fourth prediction model corresponding to the graph of FIG. 13 is about 99.3 percent. The accuracy of the fifth prediction model corresponding to the graph of FIG. 14 is about 98.6 percent. The accuracy of the sixth prediction model corresponding to the graph of FIG. 15 is about 98.9 percent. Additionally, a maximum error between the predicted ΔV and the measured ΔV in the third prediction model is about 0.4 mV. In other words, prediction models in which the second time point is determined to be about ten days or more after the first time point exhibit similar accuracies as each other.

In an embodiment, during a manufacturing process of a secondary battery, a voltage measurement may be performed during a formation process. In more detail, after the configuration of the secondary battery is assembled, the secondary battery may be charged to a fully charged state. Thereafter, as the secondary battery naturally discharges, a voltage measurement may be performed. For example, a first voltage measurement may be performed at the first time point corresponding to a time immediately after the fully charged state. The secondary battery may be subjected to a voltage measurement at the second time point corresponding to about three days after the first voltage measurement. As such, during the formation process, a voltage measurement may be performed at at least one time point.

Additionally, the secondary battery may be subjected to a voltage measurement at the third time point. As the time interval between the third time point and the second time point decreases, time and costs in the manufacturing process of the secondary battery may be reduced. In order for the prediction model to exhibit a relatively higher accuracy while reducing time and costs in the manufacturing process of the secondary battery, the third time point may be selected as a time point of about seven to ten days after the second time point. For example, the third time point may be a time point at which about seven days have elapsed from the second time point. By determining appropriate voltage-measurement time points, a prediction model exhibiting a higher estimation accuracy for the voltage value at the fourth time point (e.g., a time point associated with the reference time point) and minimized or reduced time and costs may be provided.

As described above, instead of measuring all voltage values (e.g., open-circuit-voltage values) of a secondary battery over a longer period (e.g., thirty days or more), voltage values at a suitable number (e.g., a predetermined number) of times (e.g., three times) within an initial period (e.g., a period between immediately after the discharge and ten days after the discharge) may be measured, and the voltage values over the longer period may be estimated. In addition, whether or not the secondary battery (e.g., the secondary battery under inspection) is defective may be determined based on the estimated voltage values. In other words, the secondary battery inspection method according to some embodiments may determine whether or not the secondary battery is defective by measuring voltage values a suitable number (e.g., a predetermined number) of times for a relatively shorter period (e.g., about ten days). In other words, the secondary battery inspection method may not destructively test the secondary battery, may not use various inspection devices, and may consume relatively little or less time and costs, thereby inspecting secondary batteries more efficiently.

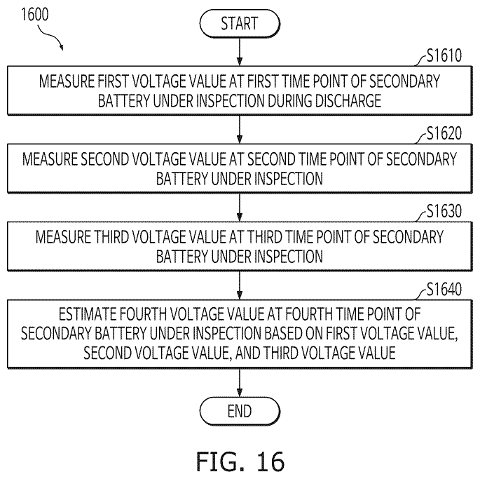

FIG. 16 is a flowchart illustrating an example of a secondary battery inspection method 1600 according to an embodiment of the present disclosure.

In an embodiment, the secondary battery inspection method may be performed by the secondary battery inspection apparatus. The secondary battery inspection apparatus may include at least one of the voltage measurement unit (e.g., the voltage measurement unit 120 of FIG. 1), the determination unit (e.g., the determination unit 130 of FIG. 1), the sorting unit (e.g., the sorting unit 140 of FIG. 1), or the reference-value calculation unit (e.g., the reference-value calculation unit 230 of FIG. 2).

Referring to FIG. 16, the secondary battery inspection method 1600 may start, and the secondary battery inspection apparatus may measure a first voltage value at a first time point of a secondary battery under inspection during a discharge (S1610). The discharge may correspond to a self-discharge.

The secondary battery inspection apparatus may measure a second voltage value at a second time point of the secondary battery under inspection (S1620).

The secondary battery inspection apparatus may measure a third voltage value at a third time point of the secondary battery under inspection (S1630).

The secondary battery inspection apparatus may estimate a fourth voltage value at a fourth time point of the secondary battery under inspection based on the first voltage value, the second voltage value, and the third voltage value (S1640), and the secondary battery inspection method 1600 may end. The first time point, the second time point, the third time point, and the fourth time point may differ from each other. For example, the first time point, the second time point, the third time point, and the fourth time point may be arranged in chronological order.

In an embodiment, the second time point may be between the first time point and a time point at which three days have elapsed from the first time point. The third time point may be between a time point at which five days have elapsed from the second time point and a time point at which ten days have elapsed from the second time point. The fourth time point may be a time point at which thirty days or more have elapsed from the second time point.

In an embodiment, the secondary battery inspection apparatus may calculate a first time interval, which is a difference between the first time point and the second time point. The secondary battery inspection apparatus may calculate a second time interval, which is a difference between the first time point and the third time point. The secondary battery inspection apparatus may estimate the fourth voltage value based on the first time interval, the second time interval, the first voltage value, the second voltage value, and the third voltage value.

In an embodiment, the secondary battery inspection apparatus may calculate a first delta voltage value, which is the difference between the first voltage value and the second voltage value, based on the first voltage value and the second voltage value. The secondary battery inspection apparatus may calculate a second delta voltage value, which is the difference between the first voltage value and the third voltage value, based on the first voltage value and the third voltage value. The secondary battery inspection apparatus may estimate the fourth voltage value based on the first delta voltage value and the second delta voltage value.

In an embodiment, the secondary battery inspection apparatus may generate a prediction model to obtain the fourth voltage value at the fourth time point based on the first time interval, the second time interval, the first delta voltage value, and the second delta voltage value. The secondary battery inspection apparatus may obtain the fourth voltage value using the prediction model. In more detail, the secondary battery inspection apparatus may calculate a third time interval, which is a difference between the first time point and the fourth time point. The secondary battery inspection apparatus may obtain the fourth voltage value using the prediction model based on the third time interval.

In an embodiment, the secondary battery inspection apparatus may calculate a voltage value variation associated with a reference time point using the prediction model. The secondary battery inspection apparatus may determine whether or not the secondary battery under inspection is defective by comparing the voltage value variation with the reference value. For example, the secondary battery inspection apparatus may generate estimated voltage data associated with the reference time point using the prediction model. The secondary battery inspection apparatus may calculate the voltage value variation based on the estimated voltage data.

In an embodiment, the reference value may be calculated, from voltage data of a plurality of test secondary batteries under a discharge, based on a differential value of voltage data at the reference time point. For example, the reference time point may be associated with a time point at which the differential value of the voltage data becomes constant or substantially constant. As another example, the reference time point may be a time point at which thirty days or more have elapsed from the day on which the discharge starts.

In an embodiment, the reference value may be calculated from voltage data of a plurality of test secondary batteries under a discharge, based on a standard deviation of the differential values of voltage data at the reference time point. For example, the reference value may fall within a range of 0.05-0.06205 mV/day.

In an embodiment, when the voltage value variation exceeds the reference value, the secondary battery inspection apparatus may determine whether or not the secondary battery under inspection is defective after a second inspection. For example, the defect may be associated with a secondary battery having an internal short circuit. For example, a frozen resistance associated with the defective secondary battery may be less than or equal to a reference resistance.

The flowchart described above with reference to FIG. 16 provides an illustrative example of a method of the present disclosure, and the present disclosure is not limited to the flowchart described above with reference to FIG. 16. For example, one or more processes may be added, changed, or deleted, the order of one or more processes may be changed, or one or more processes may be performed concurrently (e.g., simultaneously or substantially simultaneously) with each other.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

### DESCRIPTION OF SOME REFERENCE SYMBOLS

110: secondary battery under inspection
120: voltage measurement unit
130: determination unit
140: sorting unit

What is claimed is:

1. A secondary battery inspection method comprising:
measuring a first voltage value at a first time point of a secondary battery under inspection during a discharge;
measuring a second voltage value at a second time point of the secondary battery under inspection;
measuring a third voltage value at a third time point of the secondary battery under inspection; and
estimating a fourth voltage value at a fourth time point of the secondary battery under inspection based on the first voltage value, the second voltage value, and the third voltage value,
wherein the first time point, the second time point, the third time point, and the fourth time point are different from each other.

2. The secondary battery inspection method according to claim 1, wherein the first time point, the second time point, the third time point, and the fourth time point are in chronological order.

3. The secondary battery inspection method according to claim 1, wherein the second time point is between the first time point and a time point at which 3 days have elapsed from the first time point.

4. The secondary battery inspection method according to claim 1, wherein the third time point is between a time point at which 5 days have elapsed from the second time point and a time point at which 10 days have elapsed from the second time point.

5. The secondary battery inspection method according to claim 1, wherein the fourth time point is a time point at which greater than or equal to 30 days have elapsed from the second time point.

6. The secondary battery inspection method according to claim 1, wherein the estimating of the fourth voltage value comprises:
calculating a first time interval as a difference between the first time point and the second time point;
calculating a second time interval as a difference between the first time point and the third time point; and
estimating the fourth voltage value based on the first time interval, the second time interval, the first voltage value, the second voltage value, and the third voltage value.

7. The secondary battery inspection method according to claim 1, wherein the estimating of the fourth voltage value comprises:
calculating a first delta voltage value as a difference between the first voltage value and the second voltage value, based on the first voltage value and the second voltage value;
calculating a second delta voltage value as a difference between the first voltage value and the third voltage value, based on the first voltage value and the third voltage value; and
estimating the fourth voltage value based on the first delta voltage value and the second delta voltage value.

8. The secondary battery inspection method according to claim 1, wherein the estimating of the fourth voltage value comprises:
calculating a first time interval as a difference between the first time point and the second time point;
calculating a second time interval as a difference between the first time point and the third time point;
calculating a first delta voltage value as a difference between the first voltage value and the second voltage value, based on the first voltage value and the second voltage value;
calculating a second delta voltage value as a difference between the first voltage value and the third voltage value, based on the first voltage value and the third voltage value;
generating a prediction model configured to acquire the fourth voltage value at the fourth time point based on the first time interval, the second time interval, the first delta voltage value, and the second delta voltage value; and
acquiring the fourth voltage value using the prediction model.

9. The secondary battery inspection method according to claim 8, wherein the acquiring of the fourth voltage value comprises:
calculating a third time interval as a difference between the first time point and the fourth time point; and
acquiring the fourth voltage value using the prediction model based on the third time interval.

10. The secondary battery inspection method according to claim 8, further comprising:
calculating a voltage value change amount associated with a reference time point using the prediction model; and
determining whether or not the secondary battery under inspection is defective by comparing the voltage value change amount with a reference value.

11. The secondary battery inspection method according to claim 10, wherein the calculating of the voltage value change amount comprises:
generating estimated voltage data associated with the reference time point using the prediction model; and
calculating the voltage value change amount based on the estimated voltage data.

12. The secondary battery inspection method according to claim 10, wherein the reference value is calculated based on a differential value of voltage data at the reference time point from voltage data of a plurality of test secondary batteries under a discharge.

13. The secondary battery inspection method according to claim 12, wherein the reference time point is associated with a time point at which the differential value of the voltage data becomes constant.

14. The secondary battery inspection method according to claim 12, wherein the discharge corresponds to a self-discharge, and
wherein the reference time point is a time point at which greater than or equal to 30 days have elapsed from a day on which the discharge started.

15. The secondary battery inspection method according to claim 10, wherein the reference value is calculated based on a standard deviation of differential values of voltage data at the reference time point from voltage data of a plurality of test secondary batteries under a discharge.

16. The secondary battery inspection method according to claim 10, wherein the reference value is within a range of 0.05-0.06205 mV/day.

17. The secondary battery inspection method according to claim 10, wherein the determining of whether or not the secondary battery under inspection is defective comprises determining whether or not the secondary battery under inspection is defective after a second inspection when the voltage value change amount is greater than the reference value.

18. The secondary battery inspection method according to claim 10, wherein a determination that the secondary battery under inspection is defective corresponds to a determination that the secondary battery under inspection has an internal short circuit.

19. The secondary battery inspection method according to claim 10, wherein a frozen resistance associated with a defective secondary battery is less than or equal to a reference resistance.

20. A secondary battery inspection method comprising:
measuring a first voltage value at a first time point of a secondary battery under inspection during a discharge;
measuring a second voltage value at a second time point of the secondary battery under inspection;
measuring a third voltage value at a third time point of the secondary battery under inspection;
calculating a first time interval as a difference between the first time point and the second time point;
calculating a second time interval as a difference between the first time point and the third time point;
calculating a first delta voltage value as a difference between the first voltage value and the second voltage value;
calculating a second delta voltage value as a difference between the first voltage value and the third voltage value;
generating a prediction model configured to acquire a fourth voltage value at a fourth time point based on the first time interval, the second time interval, the first delta voltage value, and the second delta voltage value; and
acquiring the fourth voltage value using the prediction model,
wherein the first time point, the second time point, the third time point, and the fourth time point are in chronological order.
